(19) United States
(12) Patent Application Publication
(10) Pub. No.: US 2017/0191668 A1
(43) Pub. Date: Jul. 6, 2017

(54) STAGED FUEL AND AIR INJECTION IN COMBUSTION SYSTEMS OF GAS TURBINES

(71) Applicant: General Electric Company, Schenectady, NY (US)

(72) Inventors: Michael John Hughes, Pittsburgh, PA (US); Jonathan Dwight Berry, Simpsonville, SC (US); James Scott Flanagan, Greenville, SC (US)

(73) Assignee: General Electric Company

(21) Appl. No.: 14/988,999

(22) Filed: Jan. 6, 2016

(51) Int. Cl. F23R 3/34; F01D 9/04; F23R 3/00; F02C 7/22

(52) U.S. Cl. CPC F23R 3/346; F02C 7/222; F01D 9/041; F23R 3/002; F05D 2220/32

(57) ABSTRACT

A gas turbine that includes: a combustor coupled to a turbine that together define a working fluid flowpath, the working fluid flowpath extending aftward along a longitudinal axis from a forward end defined by a forward injector in the combustor, through an interface at which the combustor ends and the turbine begins, and then through the turbine to an aftward end; a gap formed at the interface between the combustor and the turbine; and a fuel injector disposed near the gap for injecting a fuel into an airflow that passes through the gap. The gap may include a former leakage pathway occurring at the interface. The former leakage pathway may be expanded so to accommodate a desired level for the airflow passing therethrough.

### BACKGROUND OF THE INVENTION

This present application relates generally to combustion systems within combustion or gas turbine engines. More specifically, but not by way of limitation, the present application describes novel systems, apparatus, and/or methods related to the downstream or axially staged injection of air and fuel in such combustion systems, as well as the cooling systems and components related therewith.

As will be appreciated, the efficiency of combustion or gas turbine engines (“gas turbines”) has improved significantly over the past several decades as advanced technologies have enabled increases in engine size and higher operating temperatures. The technical advances that have allowed such achievements include new heat transfer technologies for cooling hot gas path components as well as new more durable materials. During this time frame, however, regulatory standards have been enacted that limit the emission levels of certain pollutants. Specifically, the emission levels of NOx, CO and UHC—all of which are sensitive to the operating temperature and combustion characteristics of the engine—have become more strictly regulated. Of these, the emission level of NOx is especially sensitive to increases at higher engine firing temperatures and, thus, this pollutant has become a significant limit as to how much further firing temperatures might be increased. Because higher operating temperatures generally yield more efficient engines, this hindered further advances in efficiency. Thus, performance limitations associated with conventional combustion systems became factor limiting the development of more efficient gas turbines.

One way in which the combustion system exit temperatures have been increased, while still also maintaining acceptable emission levels and cooling requirements, is through the axially staging the fuel and air injection. This typically requires increasing air volume passing through the combustor as well as directing more of that volume to injectors axially spaced downstream relative to the primary injector positioned at the forward end of the combustor. As will be understood, this increased volume of airflow results in more significance being placed on the aerodynamic performance of the unit. More specifically, combustors that minimize the pressure drop of the compressed air moving through it may achieve performance benefits and efficiencies that, as flow levels through the combustors increase, become of greater significance. A significant portion of compressor air is consumed in cooling hot gas path components, such as turbine rotor and stator blades, particularly those in the initial stages of the turbine. Additionally, considerable amounts of air are lost due to leakage. This is particularly true in the region of the engine where the combustor connects or interfaces with the turbine section.

As a result, one of the primary goals of advanced combustion system design relates to developing staged combustion configurations and cooling strategies that enable higher firing temperatures and/or more efficient performance, while minimizing combustion driven emissions, aerodynamic pressure losses, and leakage. As will be appreciated, such technological advances would result in improved engine efficiency levels.

### BRIEF DESCRIPTION OF THE INVENTION

The present application thus describes a gas turbine that includes: a combustor coupled to a turbine that together define a working fluid flowpath, the working fluid flowpath extending aftward along a longitudinal axis from a forward end defined by a forward injector in the combustor, through an interface at which the combustor ends and the turbine begins, and then through the turbine to an aftward end; a gap formed at the interface between the combustor and the turbine; and a fuel injector disposed near the gap for injecting a fuel into an airflow that passes through the gap. The gap may include a former leakage pathway occurring at the interface. The former leakage pathway may be expanded so to accommodate a desired level for the airflow passing therethrough.

These and other features of the present application will become apparent upon review of the following detailed description of the preferred embodiments when taken in conjunction with the drawings and the appended claims.

### BRIEF DESCRIPTION OF THE DRAWINGS

These and other features of this invention will be more completely understood and appreciated by careful study of the following more detailed description of exemplary embodiments of the invention taken in conjunction with the accompanying drawings, in which:

FIG. 1 is a sectional schematic representation of an exemplary gas turbine of a type in which embodiments of the present invention may be used;

FIG. 2 is a sectional schematic illustration of a conventional combustor and surrounding systems of a type in which embodiments of the present invention may be used;

FIG. 3 is a sectional schematic representation of a conventional combustor having a staged injection system;

FIG. 4 is a sectional schematic representation of a conventional staged combustion system that provides a depiction of the working fluid flowpath as it continues into the turbine section of the engine;

FIG. 5 is a simplified sectional representation of an interface between combustor and turbine sections according to a conventional design;

FIG. 6 is a simplified sectional representation of an interface between combustor and turbine sections according to an exemplary embodiment of the present invention;

FIG. 7 is a simplified sectional representation of an interface between combustor and turbine sections according to an exemplary embodiment of the present invention;

FIG. 8 is a simplified sectional view of an interface between combustor and turbine sections according to an alternative embodiment of the present invention;

FIG. 9 is an enhanced view of the area identified by the broken line of FIG. 8 according to an exemplary embodiment of the present invention;

FIG. 10 is an alternative embodiment of the present invention of the area identified by the broken line of FIG. 8;

FIG. 11 is an alternative embodiment of the present invention of the area identified by the broken line of FIG. 8;

FIG. 12 is an alternative embodiment of the present invention of the area identified by the broken line of FIG. 8;

FIG. 13 is an alternative embodiment of the present invention of the area identified by the broken line of FIG. 8; and

FIG. 14 is a cross-sectional view taken along 13-13 of FIG. 13.

### DETAILED DESCRIPTION OF THE INVENTION

Aspects and advantages of the invention are set forth below in the following description, or may be obvious from the description, or may be learned through practice of the invention. Reference will now be made in detail to present embodiments of the invention, one or more examples of which are illustrated in the accompanying drawings. The detailed description uses numerical designations to refer to features in the drawings. Like or similar designations in the drawings and description may be used to refer to like or similar parts of embodiments of the invention. As will be appreciated, each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents. It is to be understood that the ranges and limits mentioned herein include all sub-ranges located within the prescribed limits, inclusive of the limits themselves, unless otherwise stated. Additionally, certain terms have been selected to describe the present invention and its component subsystems and parts. To the extent possible, these terms have been chosen based on the terminology common to the technology field. Still, it will be appreciate that such terms often are subject to differing interpretations. For example, what may be referred to herein as a single component, may be referenced elsewhere as consisting of multiple components, or, what may be referenced herein as including multiple components, may be referred to elsewhere as being a single component. As such, in understanding the scope of the present invention, attention should not only be paid to the particular terminology used, but also to the accompanying description and context, as well as the configuration, function, and/or usage of the component being referenced and described, including the manner in which the term relates to the several figures, and, of course, the precise usage of the terminology in the appended claims. Further, while the following examples are presented in relation to a certain type of gas turbine or turbine engine, the technology of the present invention also may be applicable to other types of turbine engines as would the understood by a person of ordinary skill in the relevant technological arts.

Several descriptive terms may be used throughout this application so to explain the functioning of turbine engines and/or the several sub-systems or components included therewithin, and it may prove beneficial to define these terms at the onset of this section. Accordingly, these terms and their definitions, unless stated otherwise, are as follows. The terms “forward” and “aft” or “aftward”, without further specificity, refer to the direction toward directions relative to the orientation of the gas turbine. Accordingly, “forward” refers to the compressor end of the engine, while “aftward” refers to the direction toward the turbine end of the engine. Each of these terms, thus, may be used to indicate movement or relative position along the longitudinal central axis of the machine or component therein. The terms “downstream” and “upstream” are used to indicate position within a specified conduit relative to the general direction of flow moving through it. As will be appreciated, these terms reference a direction relative to the direction of flow expected through the specified conduit during normal operation, which should be plainly apparent to those skilled in the art. As such, the term “downstream” refers to the direction in which the fluid is flowing through the specified conduit, while “upstream” refers to the opposite of that. Thus, for example, the primary flow of working fluid through a gas turbine, which begins as air moving through the compressor and then becomes combustion gases within the combustor and beyond, may be described as beginning at an upstream location toward an upstream or forward end of the compressor and terminating at an downstream location toward a downstream or aftward end of the turbine.

In regard to describing the direction of flow within a common type of combustor, as discussed in more detail below, it will be appreciated that compressor discharge air typically enters the combustor through impingement ports that are concentrated toward the aftward end of the combustor (relative to the combustors longitudinal central axis of the combustor and the aforementioned compressor/turbine positioning that defines forward/aft distinctions). Once in the combustor, the compressed air is guided by a flow annulus formed about an interior chamber toward the forward end of the combustor, where the airflow enters the interior chamber and, reversing its direction of flow, travels toward the aftward end of the combustor. In yet another context, the flow of coolant through cooling channels or passages may be treated in the same manner.

Additionally, given the configuration of compressor and turbine about a central common axis, as well as the cylindrical configuration about a central axis that is typical to many combustor types, terms describing position relative to such axes may be used herein. In this regard, it will be appreciated that the term “radial” refers to movement or position perpendicular to an axis. Related to this, it may be required to describe relative distance from the central axis. In this case, for example, if a first component resides closer to the central axis than a second component, the first component will be described as being either “radially inward” or “inboard” of the second component. If, on the other hand, the first component resides further from the central axis than the second component, the first component will be described herein as being either “radially outward” or “outboard” of the second component. Additionally, as will be appreciated, the term “axial” refers to movement or position parallel to an axis, and the term “circumferential” refers to movement or position around an axis. As mentioned, while these terms may be applied in relation to the common central axis that extends through the compressor and turbine sections of the engine, these terms also may be used in relation to other components or sub-systems of the engine as may be appropriate. Finally, the term “rotor blade”, without further specificity, is a reference to the rotating blades of either the compressor or the turbine, which include both compressor rotor blades and turbine rotor blades. The term “stator blade”, without further specificity, is a reference to the stationary blades of either the compressor or the turbine, which include both compressor stator blades and turbine stator blades. The term “blades” will be used herein to refer to either type of blade. Thus, without further specificity, the term “blades” is inclusive to all type of turbine engine blades, including compressor rotor blades, compressor stator blades, turbine rotor blades, and turbine stator blades.

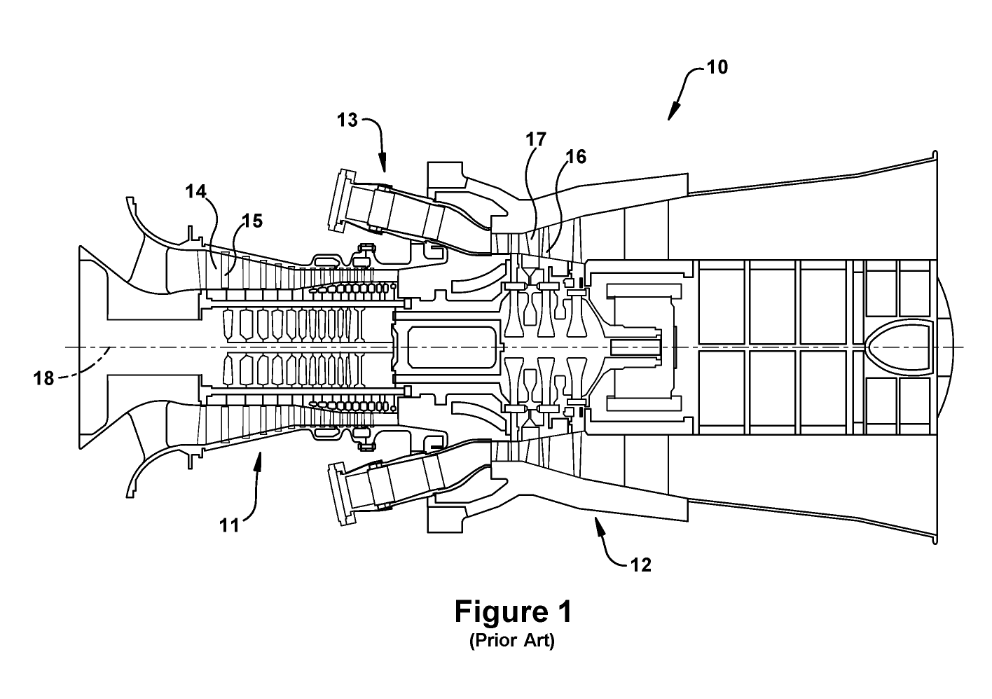

By way of background, referring now to the figures, FIG. 1 illustrates an exemplary gas turbine 10 in which embodiments of the present application may be used. It will be understood by those skilled in the art that the present invention may not be limited for use in this particular type of turbine engine, and, unless otherwise stated, the examples provided are not meant to be so limiting. In general, gas turbines operate by extracting energy from a pressurized flow of hot gases produced by the combustion of a fuel in a stream of compressed air. As illustrated in FIG. 1, the gas turbine 10 may include an axial compressor 11 that is mechanically coupled via a common shaft or rotor to a downstream turbine section or turbine 12, with a combustor 13 positioned therebetween. As shown, the common shaft of the gas turbine 10 forms a central axis 18 that extends through the compressor 11 and turbine 12.

The compressor 11 may include a plurality of stages, each of which may include a row of compressor rotor blades 14 followed by a row of compressor stator blades 15. Thus, a first stage may include a row of compressor rotor blades 14, which rotates about the central axis 18, followed by a row of compressor stator blades 15, which remains stationary during operation. The turbine 12 also may include a plurality of stages. In the case of the illustrated exemplary turbine 12, a first stage may include a row of nozzles or turbine stator blades 17, which remains stationary during operation, followed by a row of turbine buckets or rotor blades 16, which rotates about the central axis 18 during operation. As will be appreciated, the turbine stator blades 17 within one of the rows generally are circumferentially spaced one from the other and fixed about the axis of rotation. The turbine rotor blades 16 may be mounted on a rotor wheel or disc for rotation about the central axis 18. It will be appreciated that the turbine stator blades 17 and turbine rotor blades 16 lie in the hot gas path of the turbine 12 and interact with the hot gases moving therethrough.

In one example of operation, the rotation of the rotor blades 14 within the axial compressor 11 compresses a flow of air. In the combustor 13, energy is released when the compressed airflow is mixed with a fuel and ignited. The resulting flow of hot combustion gases from the combustor 13, which may be referred to as the working fluid, is then directed over the turbine rotor blades 16, with the flow thereof inducing the rotor blades 16 to rotate about the shaft. In this manner, the energy of the flow of working fluid is transformed into the mechanical energy of the rotating blades and, given the connection between the rotor blades and the shaft via the rotor disc, the rotating shaft. The mechanical energy of the shaft then may be used to drive the rotation of the compressor rotor blades, such that the necessary supply of compressed air is produced, and also, for example, a generator for the production of electricity, as would be the case in a power generating application.

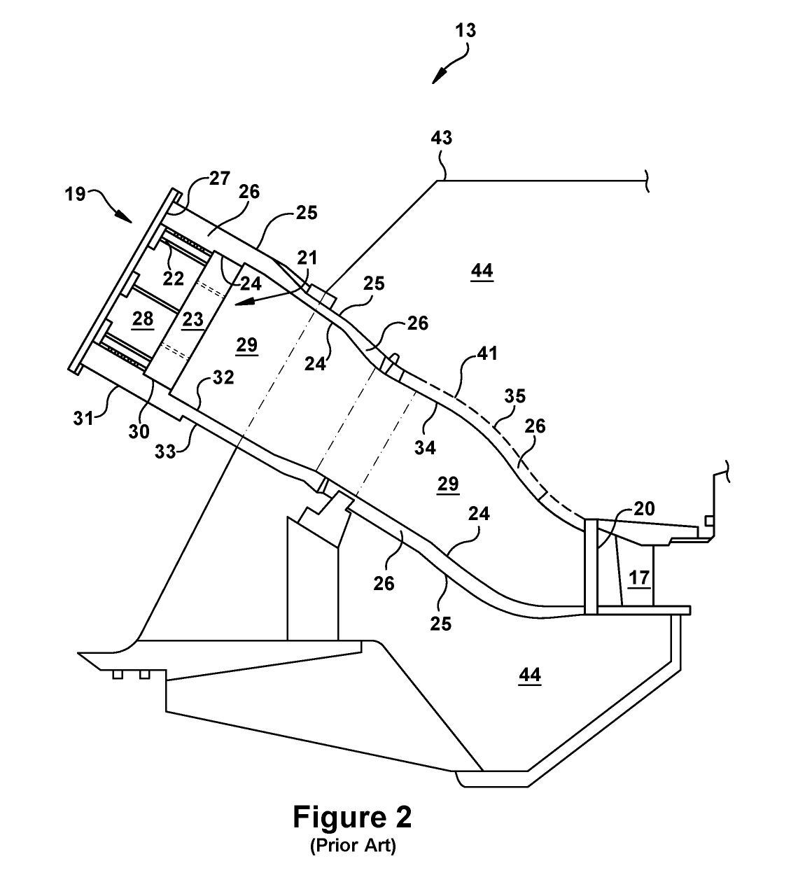

FIG. 2 provides a simplified cross-sectional view of a conventional combustor 13 and surrounding structure. As will be appreciated, the combustor 13 may be axially defined between a headend 19, which is positioned at the forward end of the combustor 13, and an aft frame 20, which is positioned at the aftward end of the combustor 13 and functions to connect the combustor 13 to the turbine 12. A forward injector 21 may be positioned toward the forward end of the combustor 13. As used herein, the forward injector 21 refers to the forward most fuel and air injector in the combustor 13, which typically serves as the primary component for mixing fuel and air for combustion within the combustion zone of the combustor 13. The forward injector 21 may connect to a fuel line 22 and include a nozzle 23. The nozzle 23 of the forward injector 21 may include any type of conventional nozzle, such as, for example, a micro-mixer nozzle, a nozzle having a swirling or swozzle configuration, or other type of nozzle that meets the functionality discussed herein. More specifically, as discussed in more detail below, the nozzle 22 is configured to be compatible with staged injection systems, as described in U.S. Pat. No. 8,019,523, which is hereby incorporated by reference in its entirety. As illustrated, the headend 19 may provide various manifolds, apparatus, and/or fuel lines 22, through which fuel may be delivered to the forward injector 21. The headend 19, as illustrated, also may include an endcover 27 that, as will be appreciated, forms the forward axial boundary of the large interior cavity that is defined within the combustor 13.

As illustrated, the interior cavity defined within the combustor 13 may be subdivided into several lesser spaces or chambers. These chambers may include airflow or air directing structure (such as walls, ports, and the like) that is configured to direct the flow of compressed air and the fuel/air mixture along a desired flow route. As will be discussed in more detail below, the interior cavity of the combustor 13 may include an inner radial wall 24 and, formed about the inner radial wall 24, an outer radial wall 25. As illustrated, the inner radial wall 24 and outer radial wall 25 may be configured such that a flow annulus 26 is defined therebetween. As further illustrated, at the forward end of the region defined within the inner radial wall 24, a forward chamber 28 may be defined, and, aftward of the forward chamber 28, an aftward chamber 29 may be defined. As will be appreciated, the forward chamber 28 is defined by a section of the inner radial wall 24 that is part of a component called a cap assembly 30. As will be appreciated, the aftward chamber 29 may define the region within which the fuel and air mixture brought together within the forward injector 21 is ignited and combusted, and, thus, also may be referred to as a combustion zone. It will be appreciated that, given this arrangement, the forward and aftward chambers 28, 29 may be described as being axially stacked in their configuration. As will be appreciated, unless otherwise specifically limited, the combustor 13 of the present invention may be arranged as an annular combustor or a can-annular combustor.

The cap assembly 30, as shown, may extend aftward from a connection it makes with the endcover 27, and be surrounded generally by an axial section of the outer radial wall 25 that may be referred herein as a combustor casing 31. As will be appreciated, the combustor casing 31 may be formed just outboard of and in spaced relation to the outer surface of the cap assembly 30. In this manner, the cap assembly 30 and the combustor casing 31 may form an axial section of the flow annulus 26 between them. As discussed more below, this section of the flow annulus 26 may be referred to a cap assembly section. As will be appreciated, the cap assembly 29 may further house and structurally support the nozzle 23 of the forward injector 21, which may be positioned at or near the aftward end of the cap assembly 30. Given this configuration, the cap assembly 30 may be described as being sectioned into two smaller, axially stacked regions, with the first of these being a forward region that is configured to accept the flow of compressed air from the flow annulus 26. The second region within the cap assembly 30 is an aftward region within which the nozzle 23 is defined.

The aftward chamber or combustion zone 29 that occurs just downstream of the forward injector 21 may be circumferentially defined by an axial section of the inner radial wall 24 that, depending on the type of combustor, may be referred to as a liner 32. From the liner 32, the aftward chamber 29 may extend aftward through a downstream section of the inner radial wall 24 that may be referred to as a transition piece 34. As will be appreciated, this axial section of the inner radial wall 24 directs the flow of hot combustion gases toward the connection that the combustor 13 makes with the turbine 12. Though other configurations are possible, within the transition piece 34 the cross-sectional area of the aftward chamber 29 (i.e., the combustion zone 29) may be configured to smoothly transition from the typically circular shape of the liner 32 to a more annular shape of the transition piece 34, which is necessary for directing the flow of hot gases onto the turbine blades in a desirable manner. As will be appreciated, the liner 32 and the transition piece 34 may be constructed as separately formed components that are joined via some conventional manner, such as mechanical attachment. According to other designs, however, the liner 32 and the transition piece 34 may be formed as an integral component or unibody. Accordingly, unless otherwise stated, reference to the inner radial wall 24 should be understood to encompass either alternative.

The outer radial wall 25, as mentioned, may surround the inner radial wall 24 so that the flow annulus 26 is formed between them. According to exemplary configurations, positioned about the liner 32 section of the inner radial wall 24 is a section of the outer radial wall 25 that may be referred to as a liner sleeve 33. Though other configurations are also possible, the liner 32 and liner sleeve 33 may be cylindrical in shape and arranged concentrically. As illustrated, the section of the flow annulus 26 formed between the cap assembly 30 and the combustor casing 31 may connect to the section of the flow annulus 26 defined between the liner 32 and liner sleeve 33 and, in this way, the flow annulus 26 extends aftward (i.e., toward the connection to the turbine 12). In similar fashion, as illustrated, positioned about the transition piece 34 section of the inner radial wall 24 is a section of the outer radial wall 25 that may be referred to as a transition sleeve 35. As shown, the transition sleeve 35 is configured to surround the transition piece 34 such that the flow annulus 26 is extended further aftward. As will be appreciated, the sections of the flow annulus 26 that are defined by the liner 32/liner sleeve 33 and the transition piece 34/transition sleeve 35 assemblies surround the combustion zone 29. As such, these sections of the flow annulus may be collectively referred to as the combustion zone section.

According to the example provided, it will be appreciated that the flow annulus 26 extends axially between a forward end defined at the endcover 27 of the headend 19 to an aftward end near the aft frame 20. More specifically, it will be appreciated that the inner radial wall 24 and the outer radial wall 25 (as may be defined by each of the cap assembly 30/combustor casing 31, the liner 32/liner sleeve 33, and the transition piece 34/transition sleeve 35 pairings) may be configured such that the flow annulus 26 extends over much of the axial length of the combustor 13. As will be appreciated, like the liner 32 and transition piece 34, the liner sleeve 33 and the transition sleeve 35 may include separately formed components that are connected via some conventional manner, such as mechanical attachment. According to other designs, however, the liner sleeve 33 and the transition sleeve 35 may be formed together as an integral component or unibody. Accordingly, unless otherwise stated, reference to the outer radial wall 25 should be understood to encompass either alternative.

The liner sleeve 33 and/or the transition sleeve 35 may include a plurality of impingement ports 41 that allow compressed air external to the combustor 13 to enter the flow annulus 26. It will be appreciated that, as shown in FIG. 2, a compressor discharge casing 43 may define a compressor discharge cavity 44 about the combustor 13. According to conventional design, the compressor discharge cavity 44 may be configured to receive a supply of compressed air from the compressor 11 such that the compressed air enters the flow annulus 26 through the impingement ports 41. As will be appreciated, the impingement ports 41 may be configured to impinge the airflow entering the combustor 13 so that fast moving jets of air are produced. These jets of air may be trained against the outer surface of the inner radial wall 24—which, as just described, may include the liner 32 and transition piece 34, or an integral unibody—so to convectively cool the inner radial wall 24 during operation. According to conventional design, once in the flow annulus 26, the compressed air is typically directed toward the forward end of the combustor 13, where, via one or more cap inlets 45 formed in the cap assembly 30, the airflow enters the forward region of the cap assembly 30. Once within the cap assembly 30, the compressed air may then be directed to the nozzle 23 of the forward injector 21 where, as mentioned, it is mixed with fuel for combustion within the combustion zone.

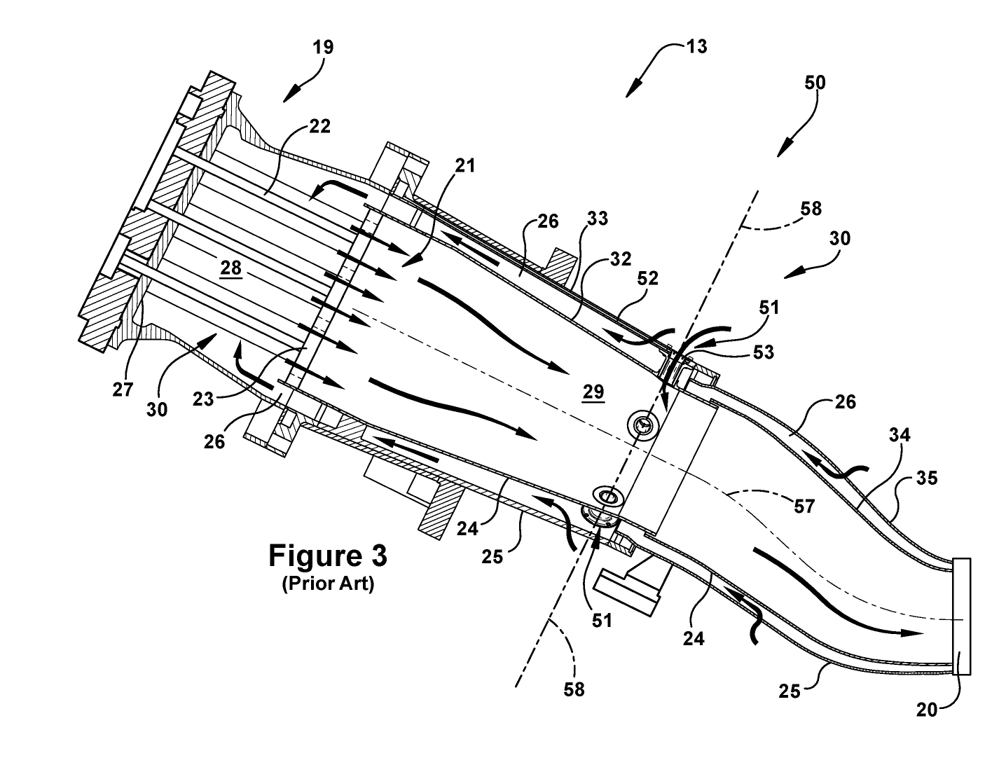

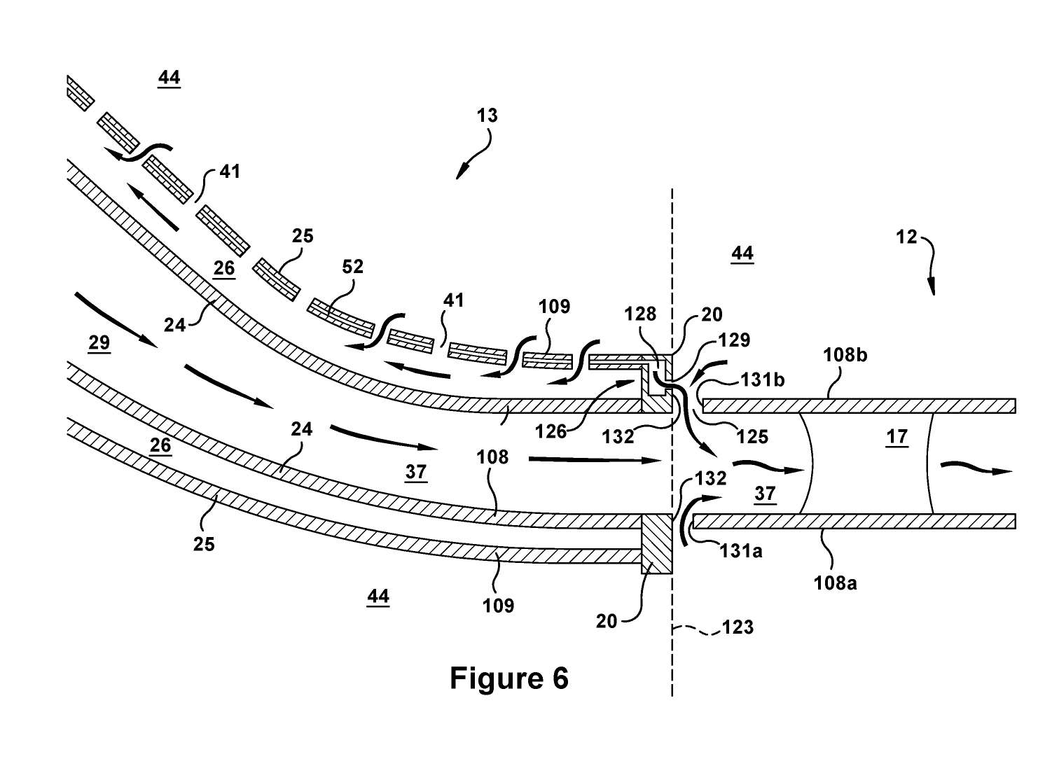

FIG. 3 illustrates a view of a combustor 13 having a staged injection system 50 that enables aftward or downstream injection of fuel and/or air into the combustion zone 29. It will be appreciated that such fuel and air injection systems are commonly referred to as supplemental injection systems, late-lean injection systems, axially staged injection systems, and the like. As used herein, aspects of these types of fuel and air injectors, injection systems, and/or the components associated therewith will be referred to generally, without limitation (except as that provided herein), as “staged injection systems.” The staged injection system 50 of FIG. 3 is consistent with an exemplary conventional design and is provided merely to introduce concepts related to staged fuel/air injection in turbine combustion systems. As will be appreciated, these concepts are applicable in explaining and understanding the operation of the invention of the present invention as set forth in FIGS. 6 through 14.

As will be understood, staged injection systems have been developed for the combustors of gas turbines for a number of reasons, including for the reduction of emissions. While emission levels for gas turbines depend upon many criteria, a significant one relates to the temperatures of reactants within the combustion zone, which has been shown to affect certain emission levels, such as NOx, more than others. It will be appreciated that the temperature of the reactants in the combustion zone is proportionally related to the exit temperature of the combustor, which corresponds to higher pressure ratios and improved efficiency levels in such Brayton Cycle type engines. Because it has been found that the emission levels of NOx has a strong and direct relationship to reactant temperatures, modern gas turbines have been able to maintain acceptable NOx emission levels while increasing firing temperatures only through technological advancements such as advanced fuel nozzle design and premixing. Subsequent to those advancements, downstream or staged injection has been employed to enable further increases in firing temperature, as it was found that shorter residence times of the reactants at the higher temperatures within the combustion zone decreased NOx levels.

In operation, as will be appreciated, such staged injection systems typically introduce a portion of the combustor total air and fuel supply downstream of what is typically the primary injection point at the forward end of the combustor. It will be appreciated that such downstream positioning of the injectors decreases the time the combustion reactants remain at the higher temperatures of the flame zone within the combustor. That is to say, due to the substantially constant velocity of the flow through the combustor, shortening the distance reactants travel before exiting the flame zone results in reduced time those reactants reside within the highest temperatures within the combustor, which, in turn, reduces the formation of NOx and lowers overall NOx emission levels for the engine. This, for example, has allowed advanced combustor designs that couple fuel/air mixing or pre-mixing technologies with the reduced reactant residence times of downstream injection to achieve further increases in combustor firing temperature and, importantly, more efficient engines, while also maintaining acceptable NOx emission levels. As will be appreciated, there are other considerations limiting the manner in which and the extent to which downstream injection may be done. For example, downstream injection may cause emission levels of CO and UHC to rise. That is, if fuel is injected in too large of quantities at locations that are too far downstream in the combustion zone, it may result in the incomplete combustion of the fuel or insufficient burnout of CO. Accordingly, while the basic principles around the notion of late injection and how it may be used to affect certain emissions may be known generally, design obstacles remain as how this strategy may be best employed so to enable more efficient engines. As these obstacles are overcome, though, and as greater opportunities for diverting larger percentages of fuel and air to downstream or axially staged injectors are realized, more efficient ways for directing the overall mass flows through the combustor may allow for performance advantages relating to reducing the overall pressure drop across the combustor and improving the efficiency and usage of cooling air and reduce air lost to leakage.

In one exemplary configuration, as shown in FIG. 3, the staged injection system 50 may include a forward injector 21 as well as one or more staged injectors 51. As used herein, staged injectors 51 are injectors axially spaced aftward from the forward injector 21. According to an exemplary arrangement, each of the staged injectors 51 may include a fuel passageway 52 that connects to a nozzle 53. Within the nozzle 53, a fuel/air mixture is created for injection into the downstream portions of the combustion zone. As illustrated, the fuel passageway 52 may be contained within the outer radial wall 25 of the combustor 13, though other apparatus and methods for fuel delivery are also possible. The fuel passageway 52 may extend in a general aftward direction between a connection to a fuel source occurring near the headend 19 and a connection with the nozzles 53 of the staged injectors 51. Though other configurations are also possible for the staged injectors 51 of such systems 50, in the example provided, multiple ones of the staged injectors 51 may be positioned about the periphery of the combustion zone 29. The axial positioning of the staged injectors 51, as shown, may be the approximate aftward end of the liner 32/liner sleeve 33 assembly. Each of the staged injectors 51 may include a nozzle 53. According to the example provided, the nozzle 53 may be configured as a tube that extends across or intersects the flow annulus 26. This tube may be configured to direct the flow therethrough for injection into the combustion zone 29. More specifically, the outboard end of the tube of the nozzle 53 may open to the compressor discharge cavity and/or ports formed that fluidly communicate with the flow annulus 26, and thereby the tube of the nozzle 53 may accept a flow of pressurized air. As discussed more below, the nozzle 53 may further include fuel ports formed through the sides of the tube structure, which may inject fuel into the pressurized air moving through it. In this manner, each of the staged injectors 51 may function to bring together and mix a supply of air and fuel and then inject the resulting mixture into the combustion zone.

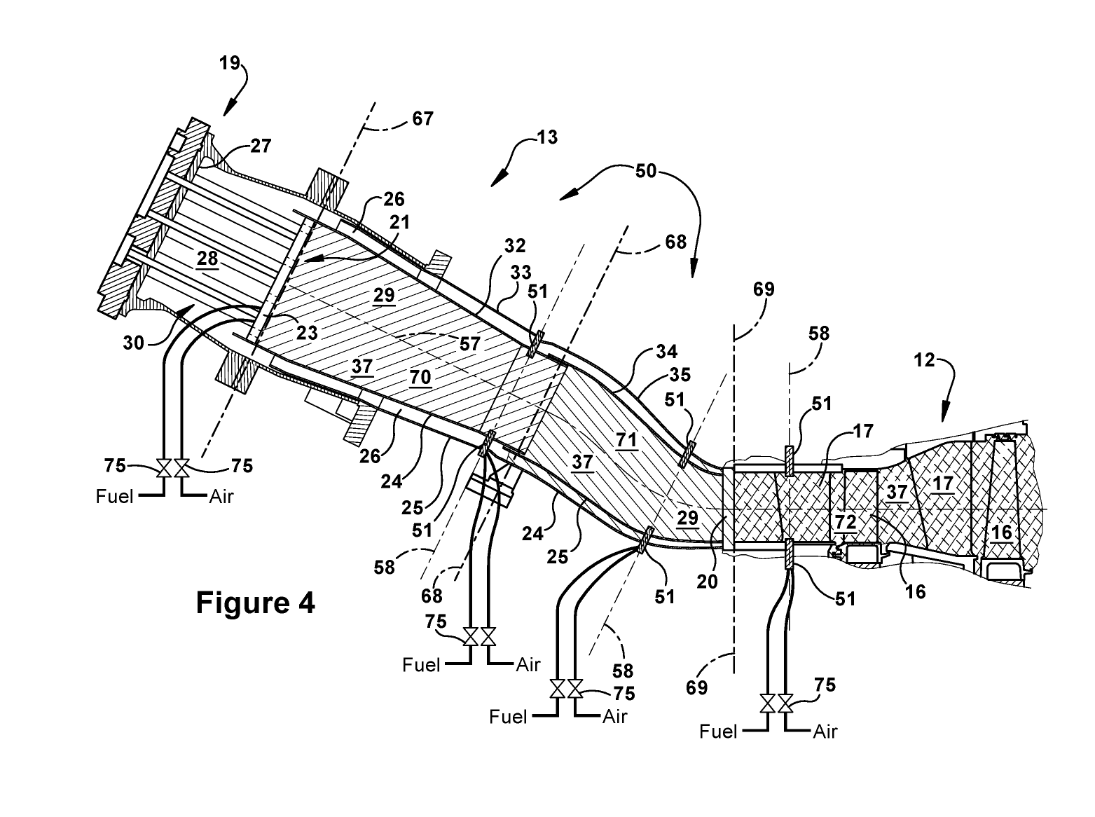

As shown in the example provided in FIG. 3, the staged injection system 50 may include several of the staged injectors 51 spaced circumferentially about the aftward chamber 29 of the combustor 13. These injectors 51 may be integrated into the liner 32/liner sleeve 32 assembly (or, more generally, the inner radial wall 24/outer radial wall 25 assembly). The staged injectors 51 may be arrayed so that a fuel/air mixture is injected at multiple circumferentially spaced points about the combustion zone. As illustrated, the staged injectors 51 may be positioned at the same or common axial position. That is to say, a plurality of the staged injectors 51 may be located about the approximate same axial position along a longitudinal or central axis 57 of the combustor 13. Having this configuration, the staged injectors 51 may be described as being positioned on a common plane, or, as it will be referred to herein, an injection reference plane 58 as indicated in FIG. 4. As will be appreciated, the staged injectors 51 may be aligned such that the injection reference plane 58 is substantially perpendicular with the central axis 57. In the exemplary configuration shown, the injection reference plane 58 is positioned at the aftward end of the liner 32/liner sleeve 33 assembly.

According to present configurations, as will be discussed in more detail below, particular placements of the staged injectors 51 are proposed. In general, the staged injectors 51 are axially spaced aftward relative to the forward injector 21 so to have a discrete axial position along the working fluid flowpath. This placement of the staged injectors 51 may be defined within an axial range along the central axis 57 of the flowpath. Such placement may be selected according to a desired performance characteristic. Further, as will be provided herein, the axial positioning of the staged injectors 51 may include positions along the aftward chamber 39 of the combustor 13 as well as positions defined within the forward stages of the turbine 12.

With reference now to FIG. 4, a cross-sectional view of a combustor 13 and the forward stages of a turbine 12 is provided, and, with reference to the areas delineated therewithin, FIG. 4 may be used to define positioning terminology within the combustor 13 and turbine 12 sections of the gas turbine 10 in relation to aspects of staged injection systems and combustor operation. Initially, in order to define axial positioning within the combustor 13, it will be appreciated that the combustor 13 and turbine 12 define a working fluid flowpath 37 that extends about a longitudinal central axis 57 from an upstream end defined by the forward injector 21 in the combustor 13 through a downstream end in the turbine 12. Accordingly, the positioning of the staged injectors 51 and other components may be defined in terms of location along this central axis 57 of the working fluid flowpath 37.

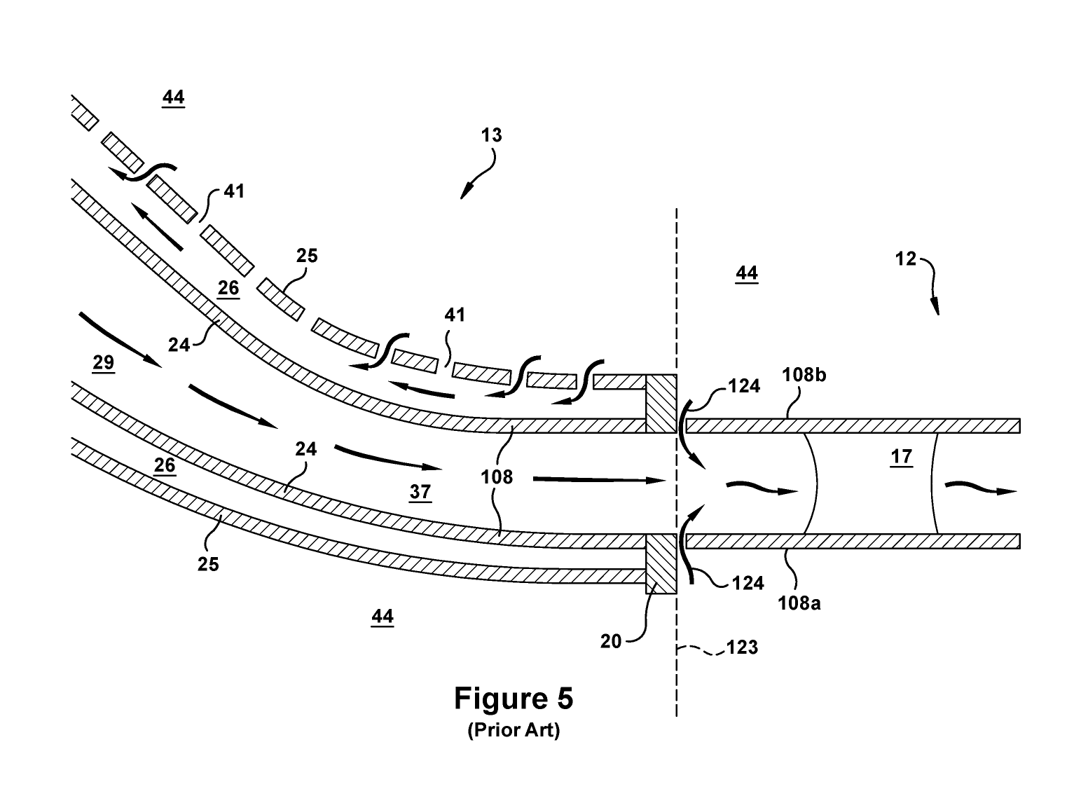

As indicated, certain perpendicular reference planes are defined in FIG. 4 so to provide clarity regarding axial positioning within the working fluid flowpath 37. As illustrated, the first of these is a forward reference plane 67 that is defined near the headend 19 of the combustor 13. Specifically, the forward reference plane is disposed at the forward end of the combustion zone 29, i.e., at the boundary between the forward chamber 28 and the aftward chamber 29 defined within the inner wall 24. Another way to describe the positioning of the forward reference plane 67 is that it is approximately located at the downstream end of the nozzle 23 of the forward injector 21 or, alternatively, at the forward end of the working fluid flowpath 37. A second of the reference planes is a mid reference plane 68. The mid reference plane 68 is positioned at the approximate axial midpoint of the aftward chamber 29 of the combustor 13, i.e., about halfway between the nozzle 23 of the forward injector and the downstream end of the combustor 13, which may be the aft frame 20. In cases where the combustor 13 includes the previously described liner 32/transition piece 34 assembly, it will be appreciated that the combustor mid-plane 68 may occur near the location at which these assemblies connect. A final one of these reference planes is an aftward reference plane 69, which, as illustrated, may be defined at the aftward end of the combustor 13. As will be appreciated, the aftward reference plane 69 marks the far, downstream end of the combustor 13, and, accordingly, as in the example provided, may be defined at the aft frame 20. Additionally, according to these reference planes 67, 68, 69, specific zones within the flowpath of the combustor 13 and the turbine 12 may be designated, which are also indicated on FIG. 4. Accordingly, an upstream combustion zone 70, as indicated, is shown occurring between the forward reference plane 67 and the mid reference plane 68. Second, a downstream combustion zone 71 is shown occurring between the mid reference plane 68 and the aftward reference plane 69. Finally, a turbine combustion zone 72 is the region designated as occurring from the end reference plane 69 through the first stages of blades 16, 17 within the turbine 12. As will be seen, each of these zones 70, 71, 72 is delineated from the other on FIG. 5 by unique crosshatch patterns.

For exemplary purposes, FIG. 4 further illustrates possible locations of a stage of the staged injectors 51 within each of the zones 70, 71, 72 described above. As will be appreciated, for the sake of clarity, the staged injectors 51 have been graphically simplified compared to the exemplary one shown in FIG. 4. It should be understood that each of these stages of the staged injectors 51 may be used alone or in concert with one or both of the other stages. As illustrated, a first stage of the staged injectors 51 is shown circumferentially spaced about an injection reference plane 58 positioned within the upstream combustion zone 70. A second stage of the staged injectors 51 is shown circumferentially spaced about a second injection reference plane 58 located within the downstream combustion zone 71. And, finally, a third stage of staged injectors 51 is shown circumferentially spaced about a third injection reference plane 58 within the turbine combustion zone 72. Accordingly, one or more stages of staged injectors 51 may be provided downstream of the forward injector 21.

The staged injectors 51 at any of the aforementioned locations may be conventionally configured for the injecting air, fuel, or both air and fuel, and a plurality may be provided at each axial location such that an array of injectors about an injection reference plane 58 is created. Though graphically simplified in FIG. 4, the staged injectors 51 of the present invention, unless otherwise stated, should be understood to include any type of conventional injector that would be appropriate for the functions described herein as would the interpreted by one of ordinary skill in the relevant technological arts. For the staged injectors 51 positioned within either the upstream combustion zone 70 or the downstream combustion zone 71, each may be structurally supported by the inner radial wall 24 and/or the outer radial wall 25, and, in some cases, may project into the combustion zones 70, 71, or, like the example of FIG. 4, the staged injector 51 may include a nozzle 53 with an end that resides flush relative to the inner radial wall 24. As will be appreciated, the staged injectors 51 may be configured to inject air and fuel in a direction that is generally transverse to a predominant flow direction through the transition zone. The staged injectors 51 that are located about an injection reference plane 58 may be several in number and positioned at regular intervals about the combustion zone 70, 71 for more uniform distribution of injected fuel/air, though other configurations are also possible.

As will be appreciated, according to certain aspects of the present invention, fuel and air may be controllably supplied to the forward injector 21 and each of the staged injectors 51 via any conventional way, including any of those mentioned and described in the patents and patent application incorporated by reference above, as well as U.S. Patent Application 2010/0170219, which is hereby incorporated by reference in its entirety. As schematically illustrated in FIG. 4 with regard to one of the staged injectors 51 within each stage in the defined zones 70, 71, 72, as well as to the forward injector 21, the staged injection system 50 may include control apparatus and related components for actively or passively controlling the delivery of fuel and/or air to each. That is, aspects of the present invention may include control apparatus, methods, systems and configurations for distributing or metering the overall fuel and air supply delivered to the combustor 13 between the staged injectors 51 and/or the forward injector 21. The forward injector 21 and the various staged injectors 51 that may be included in the staged injection system 50 may be controlled and configured in several ways so that desired operation and preferable air and fuel splitting are achieved. As represented schematically in FIG. 4, this may include actively controlling the air and fuel supplies delivered to each via a controllable valve 75, though any mechanically actuated device that functions to meter the relevant flows may also be used. It will be appreciated that active control may be achieved via connecting the controllable valves 75 to a computerized control system in which a controller electronically communicates to each valve and thereby manipulates valve settings pursuant to a control algorithm. According to other possible embodiments, the air and fuel supply to each of the staged injectors 51 as well as to the forward injector 21 may be passively controlled via relative orifice sizing of the fuel and air conduits that supply fuel and air to each. Control strategies related to the staged injection system 50 may include metering fuel and air supplies between the various staged injectors 51, the various stages (if present) of staged injectors 53, the various staged injectors 51 and the forward injector 21, or each and all.

Turning now to FIG. 5, a simplified sectional representation is provided of an interface 123 between a combustor 13 and turbine 12 in accordance with a conventional gas turbine 10. As will be appreciated, there is an ongoing design issue related to the leakage flowpath (see arrows 124) that typically develops between the combustor 13 and the turbine 12 sections of the engine. As indicated, this leakage flowpath may allow air within the compressor discharge casing 44 to bypass the combustor 13 altogether, and flow directly into the working fluid flowpath 37. As previously described and for the purposes of explanation, the working fluid flowpath 37 may extend through the combustor 13 and the turbine 12, and may be defined by and contained within a flowpath wall 108. The cross-section of the working fluid flowpath 37 through the turbine 12 may be annular in shape, and, accordingly, may be described as including an inboard flowpath wall 108a and an outboard flowpath wall 108b. Through the combustor 13, the flowpath wall 108 may correspond to the previously described inner radial wall 24.

As should be understood, the leakage path (see arrows 124) is caused by several factors inherent to the interface 123 that make sealing the region problematic. One of these factors relates to the complexity of the combustor 13 and turbine 12 assemblies in this area, which stems from the bringing together of the dissimilar flowpaths through the combustor 13 and turbine 12. More specifically, while the working fluid flowpath 37 of the turbine 12 is annularly shaped, the typical combustor 13 arrangement includes several cylindrically shaped units that feed a segment of the annular flowpath defined at the upstream end of the turbine 12. That is to say, the typical combustor configuration includes several cylindrical units that are positioned circumferentially about the central axial of the engine 10. Each of these units supplies combustion produces, i.e., working fluid, to a corresponding annular segment defined at the upstream end of the annularly shaped flowpath of the turbine 12. Thus, each of the combustor units transitions to a downstream end that is shaped according to one of the annular segments, and the units are arranged so that collectively they engage the entire annularly shape of the turbine 12. As will be appreciated, this creates many seams and joints through which leakage pathways may develop. Additionally, the upstream end of the turbine 12 typically is defined by the abutting sidewalls of the stator blades 17 of the initial stage, which results in creating more seams and joints. As should be understood, this overall arrangement results in a complex assembly with many possible leakage pathways.

Another significant factor that makes sealing the interface 123 difficult is the relative movement between the combustor 13 and the turbine 12 that occurs during normal engine operation. This movement is caused, at least in part, by the different thermal response each engine section has to transient operating modes. As will be appreciated, because of this, any effective seal must be able to accommodate significant variation in the dimensions between the surfaces of the combustor 13 and turbine 12 that defined the interface 123. This significantly restricts the type of seal that may be used, resulting in the added seal complexity and cost. This is due to the fact that many of the more cost-effective and durable sealing arrangements are unable to accommodate such movement between sealed surfaces. Given the high seal complexity required for an appropriate function, wear becomes more of an issue, as these sealing arrangements are more susceptible to damage. Such seals may perform well in the short term, but they may quickly lose effectiveness and require often replacement. Making matters still worse, when sealing performance in this region is compromised, the resulting leakage levels are usually substantial. As will be appreciated, the pressure differential across the leakage pathway of the interface is significant due to the fact that it receives the full pressure loss across the combustor 13. As such, it is not uncommon for such leakage levels to exceed 2.5% of the combustor air supply. As will be understood, this lost airflow is a direct hit to engine performance. Engine efficiency would be improved if the airflow lost through this leakage flowpath were used in the combustion process or, alternatively, to cool hot gas path components. For example, if this lost air could be used in the combustion process—such as input into a downstream or staged injector—engine firing temperatures could be increased significantly with substantially no emissions penalty.

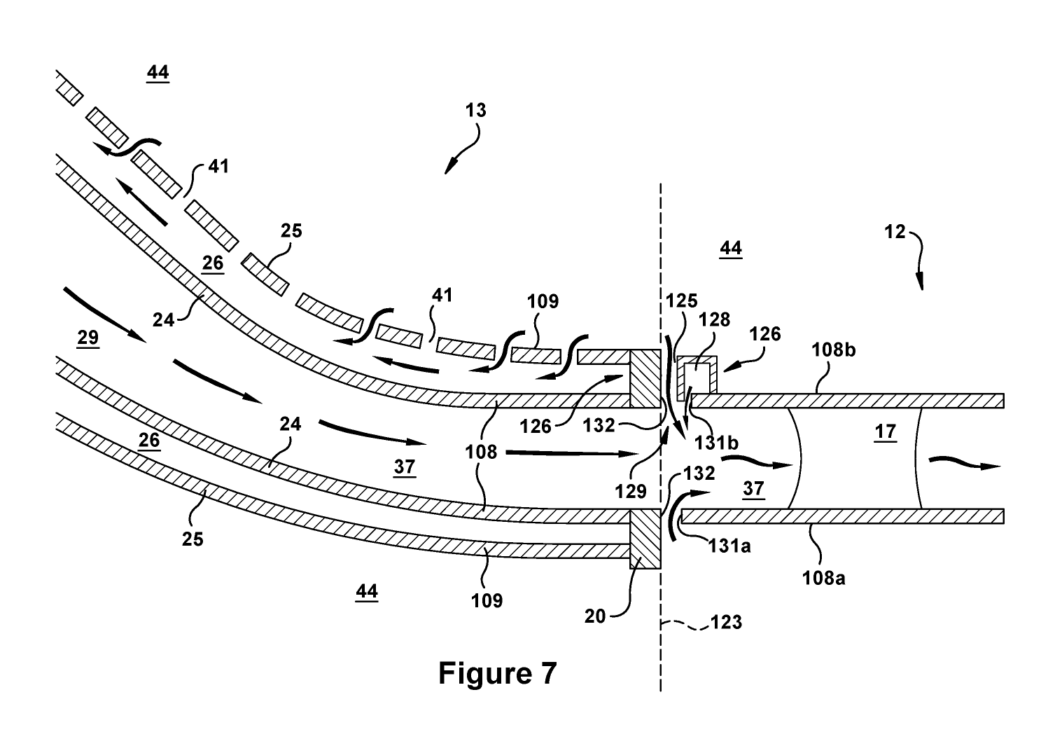

With particular reference now to FIGS. 6 through 14, several embodiments of the present invention will now be discussed. According to the following embodiments, the present application teaches how the leakage flowpath at the interface 123 may be employed in ways similar to the staged injectors 51 that were discussed above. More specifically, the present invention includes a fuel injector 126 that is positioned for use in conjunction with a leakage flowpath at the interface 123 that has been enhanced or expanded to form a gap 125, which together are used to inject fuel and air into the working fluid flowpath 37. Accordingly, with particular attention now to FIGS. 6 and 7, a gap 125 may be formed at the interface 123 between the combustor 13 and the turbine 12. The gap 125, as stated, may take the form of an expanded or exaggerated leakage pathway at the interface 123. According to the present invention, this former leakage pathway may be expanded to form the gap 125. The gap 125 may be configured so to accommodate a desired level of airflow through it given a predetermined injection rate of a fuel by the fuel injector 126. According to preferred embodiments, the gap 125 is formed as an axial gap. In such cases, the gap 125 may be defined to a forward side by structure that is rigidly attached to or part of the combustor 13 and to an aftward side by structure that is rigidly attached to or part of the turbine 12. Alternatively, as discussed more below, the gap 125 may also be formed as a radial gap 125. As will be appreciated the gap 125 may fluidly communicate with the compressor discharge cavity 44 such that the airflow flowing through the gap 125 is derived therefrom.

As illustrated, the fuel injector 126 may be positioned for injecting fuel into the airflow that passes through the gap 125. For example, as illustrated in FIG. 6, the fuel injector 126 may be attached to structure associated with the combustor 13. In such cases, as illustrated, the fuel injector 126 may be integrated into the aft frame 20. For example, the fuel injector 126 may receive a supply of fuel via a fuel passageway 52 formed in the outer radial wall 25 of the combustor 13. The fuel passageway 52 may connect to annular fuel plenum 128 formed within the aft frame 20 that feeds one or more fuel ports 129. According to an alternative embodiment, as illustrated in FIG. 7, the fuel injector 126 may be attached to or integrated within structure associated with the turbine 12. In this case, for example, the fuel injector 126 may include an annular fuel plenum 128 that is attached to the outer surface of the outboard flowpath wall 108a. As further illustrated, the fuel injector 126 may be positioned near the gap 125. However, the exact position of the fuel injector 126 relative to the gap 125 may vary somewhat depending on alternative embodiments. According to certain preferred cases, the fuel injector 126 is positioned so to inject fuel into the airflow just before the airflow enters the gap 125. Alternatively, according to other embodiments, the fuel injector 126 may be positioned so to inject fuel into the gap 125 and the airflow as it moves through the gap 125. In this manner, the fuel mixes with the airflow as the airflow flows through the gap 125. The fuel injector 126 may also be positioned so to inject fuel into the airflow just after it exits the gap 125. In this way, as will be appreciated, the gap 125 and fuel injector 126 may be configured to function similarly to the staged injectors 51, as discussed above, and employed as part of a staged injection system 50 that includes a forward injector 21 disposed near the headend 19 of the combustor 13. In this case, as will be understood, the staged injection system 50 includes the forward injector 21 and the fuel injector 126 positioned so to inject fuel into the airflow that passes through the gap 125 such that a fuel/air mixture is injected into the working fluid flowpath 37 at the aftward end of the combustor 13.

As previously discussed, the working fluid flowpath 37 through the combustor 13 and the turbine 12 may be defined by a flowpath wall 108. The cross-section of the working fluid flowpath 37 through the turbine 12 may be annular in shape, and it may be defined between an inboard flowpath wall 108a and an outboard flowpath wall 108b.

Through the combustor 13, the flowpath wall 108 may correspond to the previously described inner radial wall 24. In accordance with one exemplary type of combustor configuration, the inner radial wall 24 of the combustor 13 may have a cross-sectional shape that axially transitions between an approximate cylindrical shape (at a forward end) to a cross-sectional shape (at an aftward end) that corresponds to an annular segment of annular working fluid flowpath 37 of the turbine 12. This type of combustor configuration is often known as a can-annular configuration. As used herein, a forward edge 131 is defined the forward most edge of the flowpath wall 108 of the turbine 12. Thus, a forward edge 131a of the inboard flowpath wall 108a defines a forward most end or terminating point of the inboard flowpath wall 108a, while a forward edge 131b of the outboard flowpath wall 108b defines a forward most end or terminating point of the outboard flowpath wall 108b. Further, as used herein, an aftward edge 132 of the inner radial wall 24 is defined as an aftward most end or terminating point of the inner radial wall 24. As will be appreciated, given these designations, the gap 125 of the present invention may be defined as the axial gap 125 occurring between one or both of the forward edges of the inboard flow path wall 108a and outboard flowpath wall 108b and a corresponding opposing section of the aftward edge 132 of the inner radial wall 24.

According to alternative embodiments, the combustor 13 may also be configured as an annular combustor. In such cases, the combustor 13 may include a continuous annularly shaped flowpath that connects to the annularly shaped flowpath of the turbine 12. It will be appreciated that the combustor 13 would then include an inboard flowpath wall 108a and an outboard flowpath wall 108b in the same manner as is shown for the turbine 12 in FIGS. 6 and 7. It should be understood that, while certain examples provided herein discuss can-annular configuration, the provided illustrations and the appended claims encompass either of the possible combustor configurations—i.e., annular or can-annular—unless specifically stated otherwise.

Depending on the particular arrangement of the gas turbine 13 and in accordance with certain alternative embodiments, specific components of the turbine 12 and combustor 13 may define, respectively, the previously described forward edge 131 and afterward edge 132 and, thus, the axial boundaries of the gap 125. For example, within the turbine 12, the stator blade 17 may include inboard and outboard sidewalls that connect to each end of the airfoil 113 and thereby hold it in place. Theses inboard and outboard sidewalls of the stator blade 17 may be configured so to define, respectively, axial sections of the inboard flowpath wall 108a and the outboard flowpath wall 108b. According to certain configurations, such sidewalls may extend forward to define the forward edge 131 of the flowpath wall 108 within the turbine 12. Accordingly, in such arrangements, the inboard sidewall of the stator blades 17 may form the forward edge 131a of the inboard flowpath wall 108a, while the outboard sidewall of the stator blade 17 forms the forward edge 132b of the outboard flowpath wall 108b. As will be appreciated, the inboard sidewall, the outboard sidewall, and the airfoil 113 of the stator blade 17 may be formed as integrally components. For example, these components may be formed together via a single casting process. Pursuant to another exemplary embodiment, the combustor 13 include an aft frame 20 at an aftward most end. The aft frame 20 may be configured to structurally support the inner radial wall 24 at the aftward termination point of the combustion zone that is defined within the inner radial wall 24. In such cases, according to another exemplary embodiment, the aft frame 20 may be configured to form the aftward edge 132 of the inner radial wall 24.

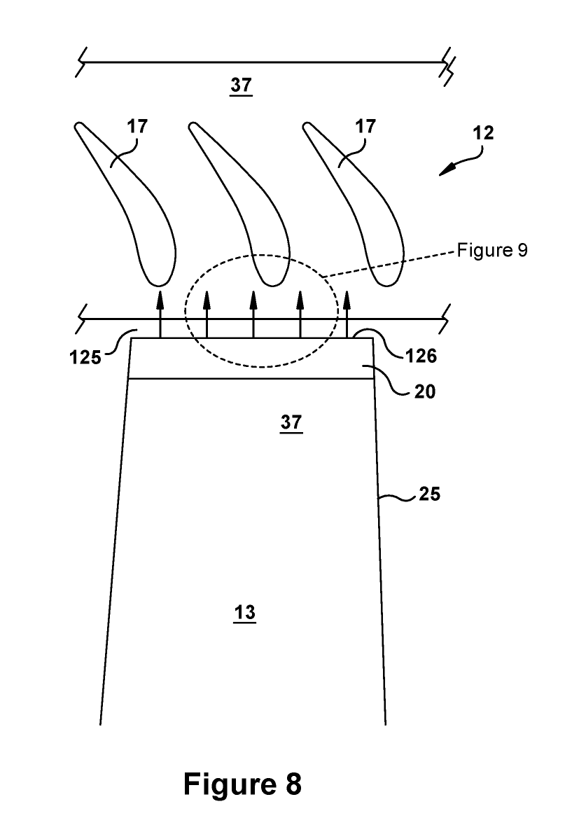

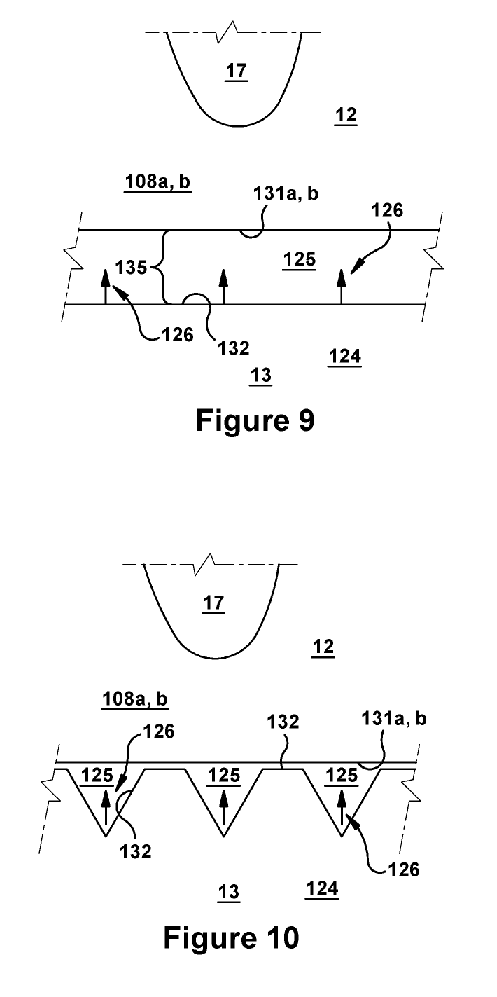

As will be appreciated, the gap 125 is formed such that a gap width 135 defines the axial distance between the forward edges 131a,b of the inboard and/or outboard flowpath wall 108a,b and the corresponding opposing section or sections of the aftward edge 132 of the inner radial wall 24. According to certain embodiments, as illustrated in FIGS. 8 and 9, the gap 125 may be configured such that the gap width 135 is substantially constant.

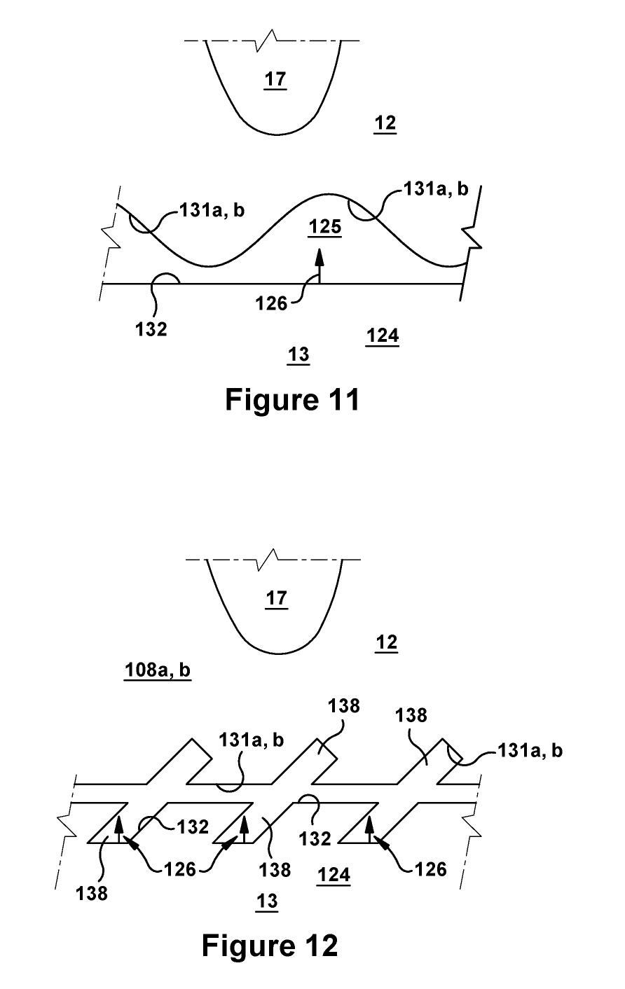

According to other embodiments, as illustrated in FIGS. 10 through 12, the gap 125 may have a variable gap width 135. In such cases, a shaped or contoured edge may be included on either: the forward edges 131a,b of the inboard and outboard flowpath walls 108a,b, the opposing section or sections of the aftward edge 132 of the inner radial wall 24, or both. The profile of the contoured edge, as shown given the perspective of FIGS. 10 through 12, may be configured in several ways. According to one embodiment, as shown in FIG. 10, the profile of the contoured edge includes a repeating triangle configuration. According to another embodiment, as illustrated in FIG. 11, the profile of the contoured edge may be configured as a smoothly shaped sinusoidal wave. As illustrated in FIG. 12, the contoured edge is formed on both the forward edges 131a,b of the inboard and outboard flowpath walls 108a,b as well as on the corresponding section of the aftward edge 132 of the inner radial wall 124. In such instances, the profile of the contoured edges may be configured to complement each other such that shapes or patterns may be achieved for the gap 125 that would not be possible otherwise. According to a preferred embodiment, as illustrated in FIG. 12, the complimentary edge profiles may include slots 138 formed on the forward edges 131a,b of the inboard and outboard flowpath walls 108a,b and the opposing section of the aftward edge 132 of the inner radial wall 24. The slots 138 may be formed so to correspond in placement such that they overlap and form a continuous slot that extends into both the structure of the turbine 12 and combustor 12. In such cases, as illustrated, the pairing of corresponding slots 138 are arranged and configured such that together they form the continuous slot, as illustrated in FIG. 12. According to a preferred embodiment, as also illustrated, the continuous slot formed by slots 138 may be canted relative the longitudinal axis of the working fluid flowpath 37. As will be appreciated, these contoured edges may be configured pursuant to desired performance advantages, such as improved fuel/air mixing, aerodynamic efficiencies, and less variance between airflow levels through the gap 125 upon relative movement between the combustor 13 and the turbine 12.

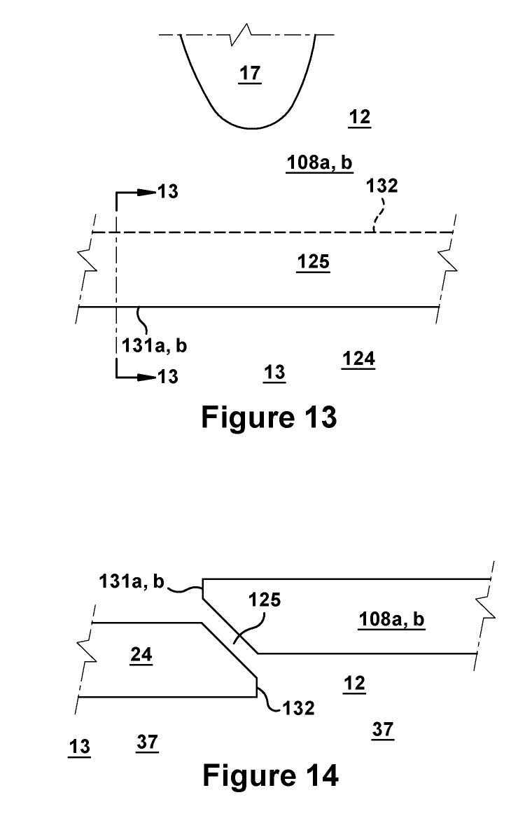

According to an alternative embodiment, as illustrated in FIGS. 13 and 14, the gap 125 may be formed as a radial gap 139. In this case, as shown, the inner radial wall 24 of the combustor 13 may be configured to axially overlap with the inboard and outboard flowpath walls 108a,b of the turbine 12. As will be appreciated, in such cases, the axial overlap may result in the outboard and the inboard flowpath walls 108a,b of the turbine 12 surrounding an aft axial section of the inner radial wall 24 of the combustor 13. Given this arrangement, as should be understood, a radial gap 139 is formed between the inner surfaces of the inboard and/or outboard flowpath walls 108a,b and corresponding opposing sections of the outer surface of the inner radial wall 24. According to a preferred embodiment, as shown more clearly in FIG. 14, the radial gap 125 may be axially canted in the inboard direction. As will be appreciated, this orientation may allow the radial gap 125 to form a shallower injection angle with respect to the direction of flow of working fluid through the working fluid flowpath 37 at that location, which is mixing losses and thereby provide improved aerodynamic performance.

Accordingly, as will be appreciated, the present invention demonstrates how a former leakage flowpath may be used as a performance-enhancing feature by reconfiguring it such that it performs as a downstream fuel/air injection point. That is to say, the present application shows how a former performance detriment—i.e., the air that was lost due to leakage through the interface 123—may be alleviated or substantially eliminated, while adding performance advantages associated with downstream or staged injection.

As one of ordinary skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, all of the possible iterations is not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

That which is claimed:

1. A gas turbine that comprises:
a combustor coupled to a turbine that together define a working fluid flowpath, the working fluid flowpath extending aftward along a longitudinal axis from a forward end defined by a forward injector in the combustor, through an interface at which the combustor ends and the turbine begins, and then through the turbine to an aftward end;
a gap formed at the interface between the combustor and the turbine; and
a fuel injector disposed near the gap for injecting a fuel into an airflow that passes through the gap.

2. The gas turbine according to claim 1, wherein the gap comprises a former leakage pathway occurring at the interface, the former leakage pathway being expanded so to accommodate a desired level for the airflow passing therethrough; and
wherein the gap comprises an axial gap defined to a forward side by structure rigidly attached to the combustor and to an aftward side by structure rigidly attached to the turbine.

3. The gas turbine according to claim 1, wherein the fuel injector comprises a staged injector, and wherein the forward injector and the fuel injector comprise a staged injection system;
further comprising:
a compressor discharge cavity formed about the working fluid flowpath for receiving a combustor air supply delivered thereto by a compressor;
circumferentially spaced stator blades positioned so to form a row of stator blades in the turbine, each of the stator blades comprising an airfoil extending across the working fluid flowpath;
fuel directing structure configured to apportion a combustor fuel supply between the forward injector and the fuel injector; and
air directing structure configured to apportion the combustor air supply between the forward injector and the gap;
wherein the combustor comprises an inner radial wall, which defines a combustion zone downstream of the forward injector, and an outer radial wall formed concentrically about the inner radial wall such that a flow annulus is formed therebetween.

4. The gas turbine according to claim 3, further comprising a flowpath wall that defines the working fluid flowpath through the combustor and the turbine;
wherein the gap comprises an axial gap defined between a forward most edge of the flowpath wall of the turbine and an aftward most edge of the flowpath wall of the combustor;
wherein the gap fluidly communicates with the compressor discharge cavity such that the airflow flowing through the gap is derived therefrom; and
wherein the combustor comprises one of an annular combustor and a can-annular combustor.

5. The gas turbine according to claim 4, further comprising a flowpath wall that defines the working fluid flowpath through each of the combustor and the turbine;
wherein, within the turbine:
the flowpath wall comprises an inboard flowpath wall that defines an inboard boundary of the working fluid flowpath and an outboard flowpath wall that defines an outboard boundary of the working fluid flowpath, the outboard flowpath wall concentrically formed about the inboard flowpath wall such that the working fluid flowpath through the turbine comprises an annular cross-sectional shape;
a forward edge of the inboard flowpath wall comprises a forward terminating point of the inboard flowpath wall; and
a forward edge of the outboard flowpath wall comprises a forward terminating point of the outboard flowpath wall.

6. The gas turbine according to claim 5, wherein the combustor comprises a can-annular combustor;
wherein the inner radial wall of the combustor comprises a cross-sectional shape that transitions axially between an approximate cylindrical shape at a forward end to a cross-sectional shape at an aftward end that corresponds to a cross-sectional shape of a segment of the annular shape of the working fluid flowpath turbine at the interface;
wherein, within the combustor:
the flowpath wall comprises the inner radial wall; and
an aftward edge of the inner radial wall comprises an aftward terminating point of the inner radial wall; and
wherein the axial gap is defined between at least one of the forward edges of the inboard and outboard flowpath walls within the turbine and a corresponding opposing section of the aftward edge of the inner radial wall within the combustor.

7. The gas turbine according to claim 5, wherein the combustor comprises an annular combustor;
wherein, within the combustor:
the flowpath wall comprises an inboard flowpath wall that defines an inboard boundary of the working fluid flowpath and an outboard flowpath wall that defines an outboard boundary of the working fluid flowpath, the outboard flowpath wall concentrically formed about the inboard flowpath wall such that the working fluid flowpath through the combustor comprises an annular cross-sectional shape;
an aftward edge of the inboard flowpath wall comprises an aftward terminating point of the inboard flowpath wall; and
an aftward edge of the outboard flowpath wall comprises an aftward terminating point of the outboard flowpath wall; and
wherein the axial gap is defined between: i) at least one of the aftward edges of the inboard and outboard flowpath walls of the combustor; and ii) at least one of the forward edges of the inboard and outboard flowpath walls of the turbine.

8. The gas turbine according to claim 4, wherein:
the airfoils of the stator blades attach to inboard sidewalls and outboard sidewalls that define, respectively, axial sections of the inboard flowpath wall and the outboard flowpath wall of the turbine; and
the combustor comprises an aft frame configured to support the flowpath wall of the combustor at an aftward end of the combustion zone;
wherein:
at least one of the inboard and outboard sidewalls of the stator blades forms the forward most edge of the flowpath wall of the turbine; and
the aft frame forms the aftward most edge of the flowpath wall of the combustor.

9. The gas turbine according to claim 8, wherein, for each of the stator blades, the inboard sidewall, the outboard sidewall, and the airfoil comprises integrally formed components.

10. The gas turbine according to claim 4, wherein the gap comprises a gap width that signifies an axial distance between the forward most edge of the flowpath wall of the turbine and the aftward most edge of the flowpath wall of the combustor; and
wherein the forward most edge of the flowpath wall of the turbine and the aftward most edge of the flowpath wall of the combustor is configured such that the gap width is substantially constant.

11. The gas turbine according to claim 4, wherein the gap comprises a gap width that signifies an axial distance between the forward most edge of the flowpath wall of the turbine and the aftward most edge of the flowpath wall of the combustor; and
wherein the forward most edge of the flowpath wall of the turbine and the aftward most edge of the flowpath wall of the combustor comprises a contoured edge such that the gap width is variable.

12. The gas turbine according to claim 11, wherein the contoured edge profile comprises a repeating triangle.

13. The gas turbine according to claim 11, wherein the contoured edge profile comprises a sinusoidal wave.

14. The gas turbine according to claim 11, wherein both of the forward most edge of the flowpath wall of the turbine and the aftward most edge of the flowpath wall of the combustor comprises the contoured edge profile; and
wherein the contoured edge profiles are configured to complement each other such that a predetermined repeating pattern is formed.

15. The gas turbine according to claim 14, wherein the repeating pattern comprises first slots formed on the forward most edge of the flowpath wall of the turbine and second slots formed on the aftward most edge of the flowpath wall of the combustor that correspond to the first slots.

16. The gas turbine according to claim 15, wherein each of a pairing of the first and second slots are aligned to form a continuous slot; and
wherein each of the continuous slots is canted relative the longitudinal axis of the working fluid flowpath.

17. The gas turbine according to claim 6, wherein the inner radial wall of the combustor axially overlaps with the inboard and the outboard flowpath walls of the turbine; and
wherein the gap comprises a radial gap.

18. The gas turbine according to claim 17, wherein the axial overlap includes the outboard and the inboard flowpath walls surrounding an axial section of the inner radial wall that is positioned therewithin, wherein the radial gap is formed between inner surfaces of the inboard and the outboard flowpath walls and corresponding opposing sections of an outer surface of the inner radial wall.

19. The gas turbine according to claim 18, wherein the radial gap is axially canted inboard so to form a shallow angle with an anticipated direction of flow of working fluid through the working fluid flowpath.

20. The gas turbine according to claim 4, wherein the fuel injector is positioned so to inject a fuel therefrom into the airflow just before the airflow enters the gap.

21. The gas turbine according to claim 4, wherein the fuel injector is positioned so to inject a fuel therefrom into the airflow while the airflow is flowing through the gap.

22. The gas turbine according to claim 4, wherein the fuel injector is positioned so to inject a fuel therefrom into the airflow just after the airflow exits the gap.

23. A gas turbine that comprises:
a combustor coupled to a turbine that together define a working fluid flowpath, the working fluid flowpath extending aftward along a longitudinal axis from a forward end defined by a forward injector in the combustor, through an interface at which the combustor ends and the turbine begins, and then through the turbine to an aftward end;
a gap formed at the interface between the combustor and the turbine;
a fuel injector disposed near the gap for injecting a fuel into an airflow that passes through the gap; and
a compressor discharge cavity formed about the working fluid flowpath for receiving a combustor air supply delivered thereto by a compressor;
wherein:
the gap comprises a former leakage pathway occurring at the interface, the former leakage pathway comprising an expanded flow area so to accommodate a desired level for the airflow passing therethrough in accordance with an expected injection rate of the fuel injected by the fuel injector;
the gap comprises an axial gap defined to a forward side by structure rigidly attached to the combustor and to an aftward side by structure rigidly attached to the turbine; and
the gap fluidly communicates with the compressor discharge cavity such that the airflow flowing through the gap is derived therefrom.
